(19) United States
(12) Patent Application Publication
(10) Pub. No.: US 2020/0267105 A1
(43) Pub. Date: Aug. 20, 2020

(54) System and Method for Trust Management

(71) Applicants: Richard Blunck, Snoqualmie, WA (US); Brendan Foley, San Francisco, CA (US); Geoff Clawson, Oakland, CA (US); Ravi Acharya, Philadelphia, PA (US)

(72) Inventors: Richard Blunck, Snoqualmie, WA (US); Brendan Foley, San Francisco, CA (US); Geoff Clawson, Oakland, CA (US); Ravi Acharya, Philadelphia, PA (US)

(73) Assignee: JPMorgan Chase, NA

(21) Appl. No.: 12/619,374

(22) Filed: Nov. 16, 2009

Related U.S. Application Data
(60) Provisional application No. 61/247,977, filed on Oct. 2, 2009.

(51) Int. Cl. H04L 12/58

(52) U.S. Cl. CPC H04L 51/16; H04L 51/18

(57) ABSTRACT

A computer-implemented trust management system is provided for facilitating charitable efforts for participating organizations through communication over a network with users of a social networking system. The trust management system comprises user interface tools for displaying a user interface through the social networking system enabling social networking system users to nominate organizations for receiving trust funds. The system additionally includes criteria verification components implemented by a computer processor for ensuring that nominated organizations comply with pre-established criteria. The system additionally includes a publication engine for facilitating publication of the compliant nominated organizations over the social networking system and for inviting social networking users to vote for the published organizations and vote processing components implemented by the computer processor for processing votes received for the published organizations, selecting winners from a first round of voting, processing votes in a second round of voting for winners of the first round of voting, and selecting winners from the second round of voting. The system additionally includes compensation processing components for awarding trust funds to the winners of both the first round of voting and the second round of voting, the publication engine further facilitating publication of details related to the awarded trust funds.

### TECHNICAL FIELD

Embodiments of the invention are related generally to systems and methods for facilitating fundraising and charitable efforts on behalf of charitable organizations.

### BACKGROUND OF THE INVENTION

Currently, a variety of mechanisms are known for fundraising for charitable organizations. Fundraising is the process of soliciting and gathering money or other gifts by requesting donations from individuals, businesses, charitable foundations, or governmental agencies.

Fundraising is a significant way that non-profit organizations may obtain the money for their operations. These operations can involve a very broad array of concerns such as philanthropic groups, research organizations, public broadcasters, and political campaigns. Further examples include scholarship organizations, humanitarian and human rights organizations, and disaster relief organizations.

One mechanism non-profit organizations use for fundraising is engaging professional fundraisers. These professional fundraisers may be paid for their services either through fees unrelated to the amounts of money to be raised, or by retaining a percentage of raised funds (percentage-based compensation). Another mechanism, frequently used in public broadcasting is the pledge drive. A further method is by entering competitions held for grant funding offered by governmental units and private foundations/charitable trusts to non-profit organizations for the benefit of all parties to the transaction. Special events, including for example, concerts, dinners, and walkathons, are another method of raising funds.

Recently, the use of online fundraising has become increasingly popular. Examples include Network for Good, Google Checkout, MissionFish, The Big Give, and the Facebook “causes” application.

Most existing methods of fundraising require considerable time and effort by employees or contractors of charitable organizations. These employees and contractors are typically compensated, thereby limiting the actual benefit that accrues to the charitable organizations.

In the business world, crowd sourcing has become known as the act of taking tasks traditionally performed by an employee or contractor and outsourcing these acts to an undefined, generally large group of people or community in the form of an open call. For example, the public may be invited to develop a new technology, carry out a design task, refine or carry out the steps of an algorithm, or help capture, systematize or analyze large amounts of data. Mass collaboration is leveraged to achieve business goals. Crowd sourcing differs from ordinary outsourcing in that the task or problem is outsourced to an undefined or loosely defined public rather than a specific entity.

Crowd sourcing can be an effective method for utilizing the skills and energy of the general public to solve problems. Because participation is voluntary, insignificant time and effort is expended by the organization attempting to solve the problem. Accordingly, a method and system for applying crowd sourcing techniques to fund raising processes would provide significant benefit to charitable organizations.

### SUMMARY OF THE INVENTION

In one aspect of the invention, a computer-implemented trust management system is provided for facilitating charitable efforts for participating organizations through communication over a network with users of a social networking system. The trust management system comprises user interface tools for displaying a user interface through the social networking system enabling social networking system users to nominate organizations for receiving trust funds and criteria verification components implemented by a computer processor for ensuring that nominated organizations comply with pre-established criteria. The system additionally comprises a publication engine for facilitating publication of the compliant nominated organizations over the social networking system and for inviting social networking users to vote for the published organizations and vote processing components implemented by the computer processor for processing votes received for the published organizations, selecting winners from a first round of voting, processing votes in a second round of voting for winners of the first round of voting, and selecting winners from the second round of voting. The system additionally comprises compensation processing components for awarding trust funds to the winners of both the first round of voting and the second round of voting, the publication engine further facilitating publication of details related to the awarded trust funds.

In an additional aspect of the invention, a computer-implemented trust management method is provided for facilitating charitable efforts for participating organizations through communication over a network with users of a social networking system. The mist management method comprises receiving nominations of participating organizations from users of the social networking system, processing the received nominations using computer processing components by verifying eligibility of the nominated organizations and causing the identities of the eligible nominated organizations to be published. The method additionally includes inviting the social networking system users to vote in a first round for at least one of the published organizations and receiving and processing the first round votes using the computer processing components to select a limited number of organizations to participate in a next round of voting, and awarding trust funds to the selected organizations from the first round of voting. The method additionally comprises facilitating publication on the social networking system of information related to the selected organizations from the first round of voting and inviting the social networking system users to vote in a second round for at least one of the selected organizations from the first round. The method further includes receiving and processing, using the computer processing components, a second round of votes from the social network users, selecting winning participating organizations from the second round of voting, facilitating publication of the winning participating organizations, and awarding additional trust funds to the selected winning participating organizations.

In yet a further aspect of the invention, a computer-implemented trust management system is provided for facilitating charitable efforts for participating organizations through communication over a network with users of a social networking system. The trust management system includes user interface tools for displaying a user interface through the social networking system enabling social networking system users to nominate organizations for receiving trust funds and nomination processing components for processing nominations received through the user interface, the nomination processing components including an exception handler for processing objections to nominations and enabling nominated organizations to overcome the objections. The system additionally includes criteria verification components implemented by a computer processor for ensuring that nominated organizations comply with pre-established criteria and a publication engine for facilitating publication of the compliant nominated organizations over the social networking system and for inviting social networking users to vote for the published organizations. Categorization components may be provided for dividing the published organizations into a number of categories based on organizational goals and vote processing components implemented by the computer processor may be provided for processing votes received for the published organizations, selecting winners from a first round of voting, processing votes in a second round of voting for winners of the first round of voting, and selecting winners from the second round of voting, wherein at least one winner is selected within each category defined by the categorization components. The system may additionally include user and cause linking components for linking each user to a corresponding participating cause on the social networking system, the link determined based on corresponding votes and nominations and membership verification components that establish social network user membership in a trust management organization operating the trust management system, the membership verification components cooperating with the vote processing components in order to weight member votes differently than non-member votes. The system may additionally include compensation processing components for awarding trust funds to the winners of both the first round of voting and the second round of voting, the publication engine further facilitating publication of details related to the awarded trust funds.

### BRIEF DESCRIPTION OF THE DRAWINGS AND EXHIBITS

The purpose and advantages of the present invention will be apparent to those of skill in the art from the description in conjunction with the appended exhibits:

FIG. 1 is a block diagram illustrating a trust management system environment in accordance with an embodiment of the invention;

FIG. 2 is a block diagram illustrating a computer system implementing a trust management engine in accordance with an embodiment of the invention;

FIG. 3 is a block diagram illustrating components of a trust management engine in accordance with an embodiment of the invention;

FIG. 4 is a flow chart illustrating an operating method for the trust management system in accordance with an embodiment of the invention;

FIG. 5 is a flow chart illustrating a method or processing participating causes in accordance with a an embodiment of the invention;

FIG. 6 is a flow chart illustrating a method of receiving and processing votes in accordance with an embodiment of the invention;

FIG. 7 is a flow chart illustrating a method for cause processing in accordance with an embodiment of the invention;

FIG. 8 is a flow chart illustrating a method for finalizing and processing winning causes in accordance with an embodiment of the invention; and

FIG. 9 is a user interface provided in accordance with an embodiment of the invention.

### DESCRIPTION OF THE INVENTION

Embodiments of the invention include a trust management system operated by a trust management organization that partners with a social networking system to donate to charities and non-profit organizations. Users of the networking system may nominate local causes or organizations and vote for those organizations which will ultimately receive donations. A component of the trust management system may function as an editorial board that has the ability to screen nominated organizations to ensure they comply with established criteria. Through the system and method of the invention, philanthropic endeavors are facilitated through the use of a social media channel. Use of the social media channel may further attract a new customer segment for the trust management organization.

The trust management system basically makes social network system users the trustees of a trust. While the trust provides funds, the users decide which organizations are deserving.

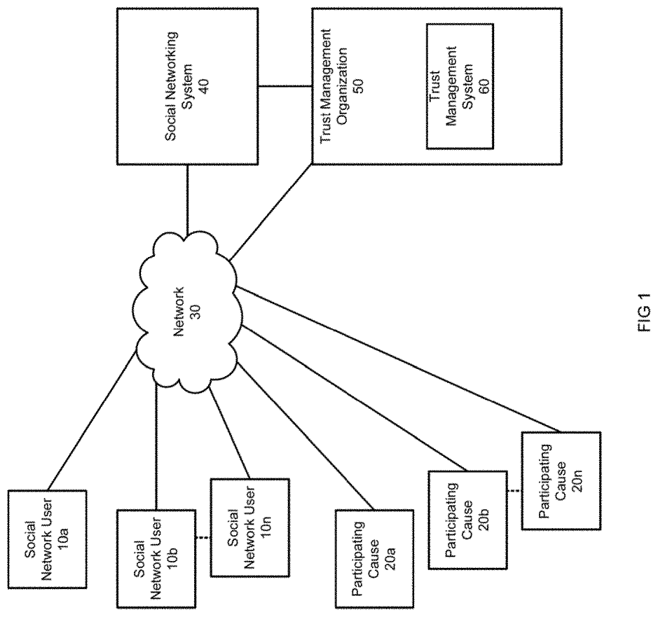

FIG. 1 is a block diagram illustrating a trust management system environment in accordance with an embodiment of the invention. A plurality of social network users 10a, 10b . . . 10n are connected over a network 30 to a social networking system 40. Participating causes 20a, 20b . . . 20n are also connected over the network 30 to the social networking system 40. A trust management organization 50 supplies a trust management system 60 for operating in conjunction with the social networking system 40. The trust management organization 50 may also be connected over the network 30 with the social networking system 40. However, the trust management organization 50 may also be integrated with the social networking system 40 more directly, such as by providing the trust management system 60 for direct operation through the social networking system 40.

The social network users 10a, 10b . . . 10n may typically be individuals connecting over the network 30 through the use of computing devices such as desktop, laptop, or portable computing devices. The social network users 10a, 10b . . . 10n may be required to be members of the social networking system 40.

The social network users 10a . . . 10n may be members of the trust management organization 50. For example, if the trust management organization 50 is a financial institution, one or more of the social network users 10a . . . 10n may hold one or more accounts with the financial institution. In embodiments of the invention, as will be further described herein, the trust management system 60 includes components for identifying and providing benefits to members of the trust management organization 50.

Furthermore, the social network users 10a . . . 10n may have an affiliation with a locality. For example, the social network users 10a . . . 10n may be associated with a neighborhood, city, state, or region of the country. While this association will often be created by virtue of the residence of the social network user, the association with a particular locality may be specifically designated by the user. For example, a social network user may want to retain an association with his or her hometown rather than his or her current residence.

The participating causes 20a, 20b . . . 20n may be charitable organizations having various purposes that have chosen to participate in the social networking system 40. In embodiments of the invention, participating causes or organizations must meet certain predetermined criteria. For example, the organization may be required to be U.S. based and registered as a 501(c)(3) organization. Organizations in the United States established for charitable purposes are allowed to raise funds from many sources. They are given a specific designation by the Internal Revenue Service (IRS), commonly noted as 501(c)(3) organizations. Other nonprofits such as fraternal associations have different IRS designations, and may or may not be eligible to raise funds.

However, in yet additional embodiments of the invention, a participating cause 20 may be an individual, family, or other group that does not necessarily comply with any specific guidelines explained herein. For example, a family may be attempting to rebuild a home destroyed by fire, may be caring for a child with cancer, or may be attempting to raise money for some other purpose. Similarly, a group that is not necessarily a non-profit may be making fundraising efforts for reasons that can be evaluated by the social network participants to determine if the group should receive funds.

Other criteria may include such factors as a limitation on the annual operating budget. For example, in embodiments of the invention, the annual operating budget may be required not to exceed $10 MM. Such a limitation would exclude many large national organizations and would encourage participation by local causes to be elected by social network users 10a . . . 10n having a particular interest in the local area served by the cause. As set forth above, each social network user may claim an affiliation with a particular locality. In an alternative embodiment, funds may be distributed to larger organizations based on a vote by nationally distributed social network users.

Additionally certain types of organizations may be excluded from participation. For example, excluded organizations may include: (1) sectarian or denominational religious organizations; (2) political organization and lobbies; (3) organization that preach, promote, and/or practice any form of discrimination or crime against humanity; and (4) foundations that are strictly grant-making (IRS 509(4)), special occasion goodwill advertising including program books, and fund-raising activities or events, raffles, giveaways, travel, or tours. Aside from the excluded organizations, any organizations meeting the predefined criteria may be permitted to participate.

The network 30 is preferably the Internet, but may be or include other types of networks. The network 30 may include a wired or wireless local area network (LAN) and a wide area network (WAN), wireless personal area network (PAN) and other types of networks. When used in a LAN networking environment, computers may be connected to the LAN through a network interface or adapter. When used in a WAN networking environment, computers typically include a modem or other communication mechanism. Modems may be internal or external, and may be connected to the system bus via the user-input interface, or other appropriate mechanism. Computers may be connected over the Internet, an Intranet, Extranet, Ethernet, or any other system that provides communications. Some suitable communications protocols may include TCP/IP, UDP, or OSI for example. For wireless communications, communications protocols may include Bluetooth, Zigbee, IrDa or other suitable protocol. Furthermore, components of the system may communicate through a combination of wired or wireless paths.

The social networking system 40 may be or include a known social networking system such as for example, Facebook, Myspace, or Twitter. The networking system may alternatively be a professional networking system such as, for example, LinkedIn. Using a social networking system such as Facebook, users can join and create groups according to their interests or areas of expertise. Users can choose fan pages according to their interests to connect and interact with other strangers. Users can also join networks organized by city, workplace, school, and region to connect and interact. With a professional networking site, such as LinkedIn, registered users are able to maintain a list of contact details of people (or connections) they know and trust in business. Users can invite anyone (whether a site user or not) to become a connection. This list of connections can then be used, for example, to build up a contact network, to find jobs or business opportunities, or to hire people seeking jobs. Another social networking system that may be implemented is Twitter, which enables its users to send and read text-based messages that are displayed on the author's profile page and delivered to the author's subscribers who are known as followers. With Twitter, senders can restrict delivery to those in their circle of friends or, by default, allow open access. Although Facebook, MySpace, Twitter, and LinkedIn are mentioned herein, similar networking systems may also or alternatively be implemented.

The trust management organization 50 may be any organization holding a trust capable of implementing the trust management system 60. In embodiments of the invention, the trust management organization 50 may be or include a financial institution. The trust management system 60 may be implemented using one or more computing devices as described below and may include a trust management engine 60. The trust management engine 60 may be or include a computer application executed by one or more processors for performing the functions described herein.

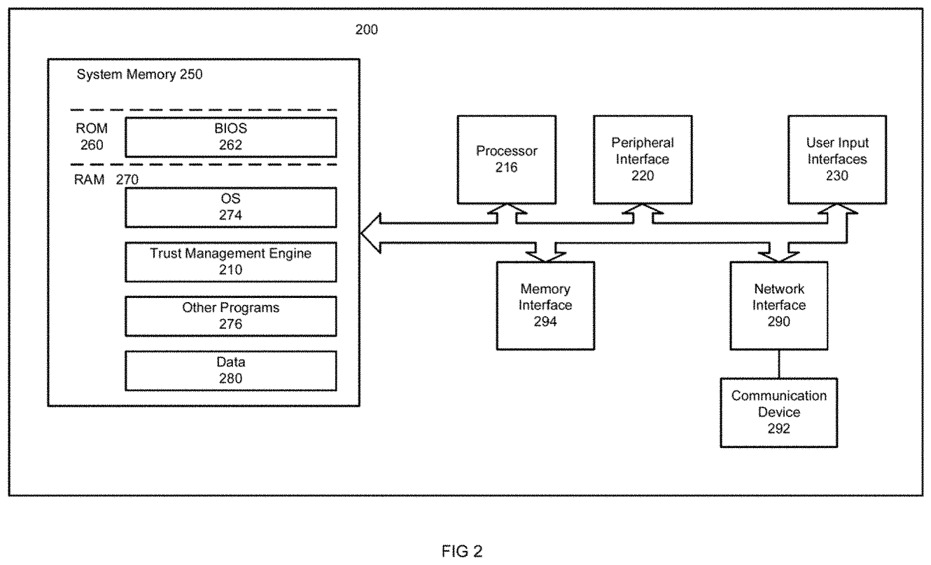

FIG. 2 is a block diagram illustrating a computing system 200 implementing a trust management engine 210 in accordance with an embodiment of the invention. This configuration is merely exemplary and should not be construed as limiting. It is likely that multiple computing systems or devices will be utilized to implement the method and system in accordance with embodiments of the invention. The computing system 200 may include a processing unit 210, a peripheral interface 220, a user input interface 230, a system bus 240, a system memory 250, a network interface 290, a connected modem, transceiver, adaptor, or other communication device 292, and a memory interface 294. The system bus 240 may be provided for coupling the various system components.

Computers typically include a variety of computer readable media that can form part of the system memory and be read by the processing unit. By way of example, and not limitation, computer readable media may comprise computer storage media and communication media. The system memory 250 may include computer storage media in the form of volatile and/or nonvolatile memory such as read only memory (ROM) 260 and random access memory (RAM) 270.

A basic input/output system (BIOS) 262, containing the basic routines that help to transfer information between elements, such as during start-up, is typically stored in ROM 260. RAM 270 typically contains data and/or program modules that are immediately accessible to and/or presently being operated on by processing unit. The data or program modules may include an operating system 274, trust management engine 210, other program modules 276, and program data 280. The operating system may be or include a variety of operating systems such as Microsoft Windows® operating system, the Unix operating system, the Linux operating system, the Xenix operating system, the IBM AIX™ operating system, the Hewlett Packard UX™ operating system, the Novell Netware™ operating system, the Sun Microsystems Solaris™ operating system, the OS/2™ operating system, the BeOS™ operating system, the Macintosh™® operating system, the Apache™ operating system, an OpenStep™ operating system or another operating system of platform.

At a minimum, the memory 250 includes at least one set of instructions that is either permanently or temporarily stored. The processor 210 executes the instructions that are stored in order to process data. The set of instructions may include various instructions that perform a particular task or tasks, such as those shown in the appended flowcharts. Such a set of instructions for performing a particular task may be characterized as a program, software program, software, engine, module, component, mechanism, or tool. The trust management engine 210 may include a plurality of software processing modules stored in a memory as described above and executed on a processor in the manner described herein. The program modules may be in the form of any suitable programming language, which is converted to machine language or object code to allow the processor or processors to read the instructions. That is, written lines of programming code or source code, in a particular programming language, may be converted to machine language using a compiler, assembler, or interpreter. The machine language may be binary coded machine instructions specific to a particular computer. Any suitable programming language may be used in accordance with the various embodiments of the invention. Illustratively, the programming language used may include assembly language, Ada, APL, Basic, C, C++, COBOL, dBase, Forth, FORTRAN, Java, Modula-2, Pascal, Prolog, REXX, and/or JavaScript for example. In embodiments of the invention, Ab Initio™ software is implemented and structured query language (SQL) is implemented for coding.

Further, it is not necessary that a single type of instruction or programming language be utilized in conjunction with the operation of the system and method of the invention. Rather, any number of different programming languages may be utilized as is necessary or desirable.

Also, the instructions and/or data used in the practice of the invention may utilize any compression or encryption technique or algorithm, as may be desired. An encryption module might be used to encrypt data. Further, files or other data may be decrypted using a suitable decryption module.

The computing environment may also include other removable/nonremovable, volatile/nonvolatile computer storage media. For example, a hard disk drive may read or write to nonremovable, nonvolatile magnetic media. A magnetic disk drive may read from or writes to a removable, nonvolatile magnetic disk, and an optical disk drive may read from or write to a removable, nonvolatile optical disk such as a CD ROM or other optical media. Other removable/nonremovable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The storage media are typically connected to the system bus through a removable or non-removable memory interface.

The processing unit 210 that executes commands and instructions may be a general purpose computer, but may utilize any of a wide variety of other technologies including a special purpose computer, a microcomputer, mini-computer, mainframe computer, programmed micro-processor, micro-controller, peripheral integrated circuit element, a CSIC (Customer Specific Integrated Circuit), ASIC (Application Specific Integrated Circuit), a logic circuit, a digital signal processor, a programmable logic device such as an FPGA (Field Programmable Gate Array), PLD (Programmable Logic Device), PLA (Programmable Logic Array), RFID processor, smart chip, or any other device or arrangement of devices that is capable of implementing the steps of the processes of the invention.

It should be appreciated that the processors and/or memories of the computer system need not be physically in the same location. Each of the processors and each of the memories used by the computer system may be in geographically distinct locations and be connected so as to communicate with each other in any suitable manner. Additionally, it is appreciated that each of the processor and/or memory may be composed of different physical pieces of equipment.

A user may enter commands and information into the computer through a user interface 230 that includes input devices such as a keyboard and pointing device, commonly referred to as a mouse, trackball or touch pad. Other input devices may include a microphone, joystick, game pad, satellite dish, scanner, voice recognition device; keyboard, touch screen, toggle switch, pushbutton, or the like. These and other input devices are often connected to the processing unit through a user-input interface that is coupled to the system bus, but may be connected by other interface and bus structures, such as a parallel port, game port or a universal serial bus (USB).

One or more monitors or display devices may also be connected to the system bus via an interface 220. In addition to display devices, computers may also include other peripheral output devices, which may be connected through an output peripheral interface. The computers implementing the invention may operate in a networked environment using logical connections to one or more remote computers, the remote computers typically including many or all of the elements described above.

Various networks may be implemented in accordance with embodiments of the invention. These networks may include any of those described above with reference to FIG. 1. Although many other internal components of the computer are not shown, those of ordinary skill in the art will appreciate that such components and the interconnections are well known. Accordingly, additional details concerning the internal construction of the computer need not be disclosed in connection with the present invention.

Those skilled in the art will appreciate that the invention may be practiced with various computer system configurations, including hand-held wireless devices such as mobile phones or PDAs, multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote computer storage media including memory storage devices.

Although the aforementioned components are shown as discrete modules, each of the modules may alternatively be integrated with one another. If the modules are discrete, multiple modules may operate cooperatively as will be further explained below.

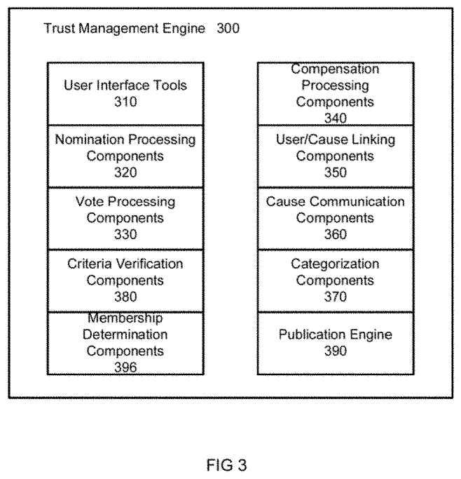

FIG. 3 is a block diagram illustrating components of a trust management engine 300 in accordance with an embodiment of the invention. FIG. 3 illustrates user interface tools 310, nomination processing components 320, vote processing components 330, compensation processing components 340, user/cause linking components 350, cause communication components 360, categorization components 370, criteria verification components 380, publication engine 390, and membership determination components 396. The uses of these components will be further discussed with respect to the flowcharts and exhibits further described herein. As explained above, these components may be or include software modules executed by one or more computer processors. Although shown as discrete modules, these components may be integral or may be further sub-divided in accordance with embodiments of the invention.

User interface tools 310 are provided in order to enable the social network users and participating causes to vote, nominate, publish information, and perform other system functions. The user interfaces provided are designed for ease of operation by all system participants.

Nomination processing components 320 are provided to process nominations and to ensure that nominated causes are eligible to receive trust funds. The nomination processing components 320 may further include exception handling capabilities, which will be further explained with reference to the figures below.

Vote processing components 330 are provided in order to count votes submitted by system users for participating causes. In some instances, the vote processing components 330 may include a weighting mechanism such that some votes are more heavily weighted than others. This weighting process will be more fully explained with reference to the figures described below. Furthermore, the vote processing components 330 may determine when each participating cause has a sufficient number of votes to qualify for a next round of voting and/or to qualify as a winning cause.

Compensation processing components 340 are provided to determine and dispense appropriate compensation to causes receiving the requisite votes. As will be further explained below, the amount of compensation may vary depending upon the number of selected participants. Furthermore, the manner of providing compensation may vary depending upon the selected causes. For example, if the selected cause is a member of the trust management organization, the compensation may be directly dispensed to a predetermined or selected account of the selected cause.

User/Cause linking components 350 may be provided in order to link social networking users with causes. For example, if a social networking user nominates a particular cause, the nominating user may become linked to that cause. Furthermore, if a social networking user votes for a cause, the social networking user may become linked to the cause. If the social networking system is Facebook, the user may become linked to the cause by becoming a “fan” of the cause.

Cause communication components 360 may keep participating organizations informed regarding nominations, votes, and awarded compensation. Cause communication components 360 may further provide user interfaces enabling the participating organizations to interact with the system.

Categorization components 370 are provided to work in conjunction with the nomination processing components to divide causes by category. Through the categorization components 370, causes with distinct purposes may not be required to compete against one another for funds. For example, a human rights organization may not compete against a cancer research organization. Accordingly, deserving organizations in multiple categories may be selected to receive funds.

Criteria verification components 380 may be provided to verify that nominated organizations are eligible. Eligibility requirements may be stored in a computer memory of the trust management system.

Publication engine 390 is provided in order to publish and update status with respect to nominations, votes, and selected causes. The publication engine 390 may further be implemented to publish the ongoing usage of received compensation by selected organizations.

Membership determination components 396 may be implemented to determine whether social network members and participating causes are members of the trust management organizations. Social network members who hold an account with the trust management organization may be entitled to a more heavily weighted vote than non-members and may further be entitled to matching contributions from the trust management organization.

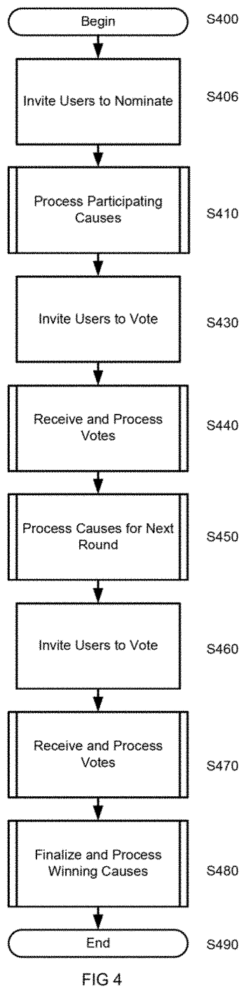

FIG. 4 is a flow chart illustrating an operating method for the trust management system in accordance with an embodiment of the invention. The method begins in S400 and S406 users are invited to nominate causes or organizations. In embodiments of the invention, the users are not required to select from a pre-defined list. The trust management organization allows user to nominate any organization. The network user may be permitted to make these nominations through the social networking system using words, pictures, videos, etc. The users may be given a time limit to submit the nominations, for example, the nomination may be required within one week of posting on the social networking site. The nominations may be limited to a specific number of photos and a specific number of words in accordance with embodiments of the invention.

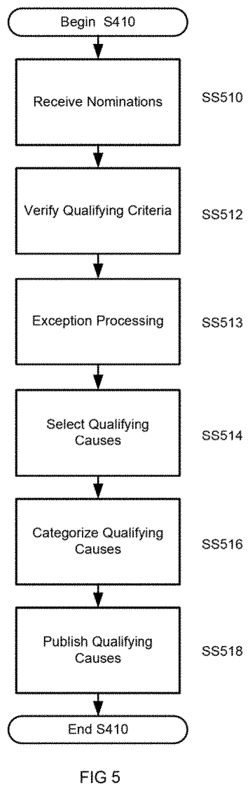

In S410, the system processes participating causes as will be further explained with respect to FIG. 5. Users are invited to vote for the nominated and qualifying causes or organizations in S430.

In S440, the system receives and processes the votes. In S450, the system processes elected organizations for a next round of voting. In S460, the system invites users to participate in the next round of voting. In S470, the system receives and processes the votes. In S480, the system finalizes and processes the winning causes or organizations before the process ends in S490.

In embodiments of the invention, the number of initial causes may be in the thousands. A first round of voting may limit the number of causes to one thousand or less. The final round may reduce the number of selected causes to for example, approximately one hundred causes. Any number of voting rounds may be included. Thus, through allowing all system users to vote in more than one round to create a short list, many deserving causes receive compensation and all of the causes receive visibility. Although the steps are illustrated in a particular order, it should be understood that various steps could be performed in a different order and the sequence of the flowchart should not be viewed as limiting. Furthermore, many of the various steps described above include sub-steps, which will be described in conjunction with FIGS. 5-8.

FIG. 5 is a flow chart illustrating a method of processing participating causes from S410 of FIG. 4 in accordance with a an embodiment of the invention. S410 begins with receiving nomination of causes in SS510. In SS512, the system verifies the criteria explained above or any other predetermined criteria for the causes responding to the invitation. For example, as set forth above, the system may verify that the causes are 501(c)(3) organizations.

In SS513, exception processing may be performed for causes that have not been successfully verified. Exception processing may, in embodiments of the invention involve a challenge round, in which participants may challenge the eligibility of nominated organizations. For example, some social network users may challenge a nominated cause on the grounds that it unfairly discriminates against a group or class of people. The nominated cause may be provided with a chance to respond to these objections. The exception processing may include a number of different procedures depending upon the nature of the unverified criteria.

In SS514, the system selects qualified causes for participation and in SS516, the system may categorize the qualifying causes. The trust management organization may determine the categories, which may include for example, arts, education, healthcare, etc.

In SS518, the system may publish the qualifying causes to the social networking system so that system users can vote on the causes. It should be noted that FIG. 5 provides only one cause selection embodiment. Instead of inviting all causes, the system may determine qualifying causes prior to inviting them for participation. Thus all causes or organizations accepting the invitation may participate up to a set numerical limit. Additionally, a limit per category may be imposed, so that categorization of the causes may occur prior to selection of the causes for participation.

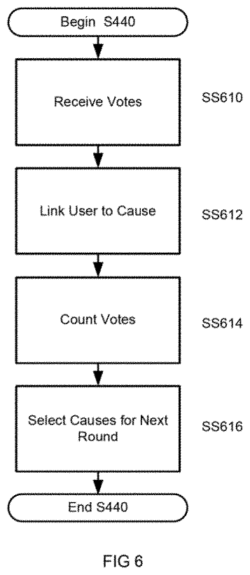

FIG. 6 is a flow chart illustrating a method of receiving and processing votes of S440 of FIG. 4 in accordance with an embodiment of the invention. The method begins as the system receives votes in SS610. Social networks users may, in embodiments of the invention, be allowed one vote per category.

Upon receiving the votes in SS610, the system may link each voting system user to the cause or the organization for which the user casts his or her vote in SS612. Linking may be accomplished in conformity to social networking system norms. For example, in the Facebook social network system, the user may be become a “fan” of the organization. In the Linked In social networking system, the voter and the organization May become connections or the voter may become a member of the organization. Furthermore, the linking components may also link the user to the trust management organization, such that the user becomes connected the trust management organization over the social networking system. Thus, once users have nominated a cause and/or voted for a cause, the users become “fans” of the trust management organization and the trust management activity is visible to their social networking friends.

SS614, the system may count the votes. Based on the vote count, in SS616, the system may select a limited number of causes for participation in the next round of voting. In embodiments of the invention, the vote count may be dependent upon membership verification. For example, votes from trust management organization members may be more heavily weighted than votes from non-members. Again, the system may perform these steps in a different order. For example, each vote may be counted before the voting user is linked to the organization. Additionally, although this method is described in connection with the preliminary round of voting of S440 of FIG. 4, a similar method may be implemented for the final round of voting in connection with S470 of FIG. 4. In the final round, a number of finalists, for example one thousand finalists, will be voted on by category, resulting in a number of categories, for example ten categories with ten winners each (or one hundred winners in total). Of course, these numbers are merely exemplary. The method may include more than two rounds of voting and/or selection processes.

In embodiments of the invention, all rounds of voting are open to any social network users, whether or not those users voted in an earlier round or plan to vote in a later round and votes are re-counted for each round. In alternative embodiments, participants must vote in the earlier rounds in order to vote in subsequent rounds. While in some embodiments of the invention, each social network user may be entitled to one vote per round, in other embodiments, users may be entitled to vote multiple times within a predetermined time period, Furthermore, embodiments may exist in which members of the trust management organization may vote multiple times while non-members are entitled to only one vote.

In alternative embodiments, votes in earlier rounds may be carried over to subsequent rounds. For example, if a social network user votes for a cause that advances to the next round, that user's vote is counted again in the next round. Thus, the social network user will continue to have his vote counted until his selected cause fails to advance to the next round. When this occurs, the system may send the social network user a reminder to vote in the next round.

Additionally, in embodiments of the invention, the trust management system may send reminders to potential voters. The reminders may be in the form of text messages, emails, or any other feasible transmission format. A direct response to the transmitted reminder may be counted as a vote.

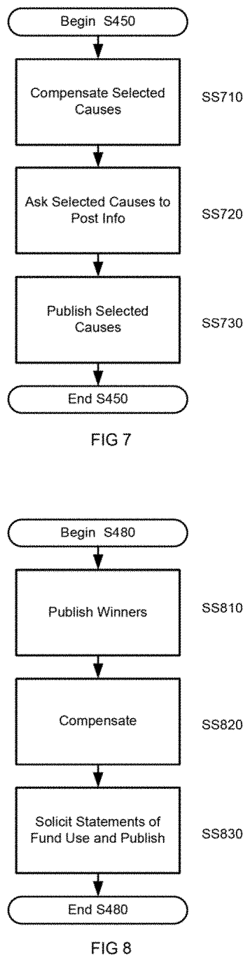

FIG. 7 is a flow chart illustrating a method for cause processing of S450 of FIG. 4 in accordance with an embodiment of the invention. In SS710, the system compensates the selected causes with a predetermined preliminary amount. The amount may, for example, be one thousand dollars and the number of selected causes may for example be one thousand causes. In embodiments of the invention, the manner and amount of compensation may also be dependent upon the membership status of the cause. For example, if the cause is a member of the trust management organization, matching funds may be provided and fund transfer may be executed directly to a linked account. In SS720, the system asks the cause to publish information through the social networking system. These selected finalists may then have an opportunity to submit word and video entries promoting their causes. The entries may be limited, for example to one hundred word entries and thirty seconds of video.

Compensation may be decided in accordance with a stored fund allocation algorithm. The stored fund allocation algorithm may manipulate a number of variables to determine an appropriate distribution. For example, the algorithm may consider the category of the organization, the locality of the organization, the total number of participating organizations, the number of votes received by each participating organization, or any number of other factors.

In SS730, the system may cause a list of the selected causes to be published through the social networking system. Again, the order of these steps may be varied in accordance with embodiments of the invention. The criteria verification components may again act in a similar manner to an editorial board to review the selected winners to ensure they meet established criteria.

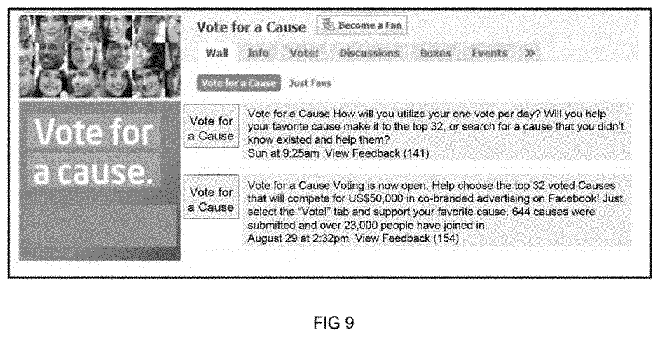

FIG. 8 is a flow chart illustrating a method for finalizing and processing winning causes of S480 of FIG. 4 in accordance with an embodiment of the invention. After processing the votes for the second round as explained above, the system may publish the winners through the social networking site in SS810. If for example, one thousand causes were entered in the round, the system may select one hundred winners after counting the votes.

In SS820, the system may compensate the winners. In this winning round, the winners are likely to receive a larger amount, for example, ten thousand dollars. In embodiments of the invention, one hundred winners may be awarded ten thousand dollars each (Total Donation=$1 M). Additionally, one top winner per category will be awarded one hundred thousand dollars (Total Donation=$1 M) In SS830, the system may solicit statements of use of the funds from the winning organization and publish these statements through the social networking system. In embodiments of the invention, the organizations may post regular updates regarding their fund usage on the social networking system and on a website hosted by the trust management organization. Again, the order of the steps may be revised in accordance with embodiments of the invention.

The top winners (for example one hundred winners) are able to submit a “grant” for their extraordinary “wish” to be voted on by the social networking community. The final winner may be awarded a large sum such as one million dollars or more. The trust management organization may “follow the winners” and feature their stories on the social networking system and on the trust management organization website.

Although the method steps described above refer to voting and selection steps, the method may further include donation steps from the system users. For example, the users may choose to make a donations to their selected organization. In embodiments of the invention, the trust management organization may provide a complete match or a partial match to benefit the charity.

Furthermore, although in embodiments of the invention, each user votes only once, other embodiments allow users extra votes under various circumstances. The circumstances may include, for example, the user contributing to the charity, or the user referring other users to vote for and/or contribute to the charity.

FIG. 9 is a user interface 900 provided in accordance with an embodiment of the invention. The method described above involves a combination of front end metrics and back end processing. The front end metrics are further enhanced by the provisions of interactive user interfaces as shown in FIG. 9. These user interfaces may be provided by the user interface tools 310 shown in FIG. 3. While the user interface shown is directed to the voter participants in the social networking system, user interfaces may also be provided for ease of use by the causes or organizations.

Thus, embodiments of the invention implement crowd sourcing as a distributed problem-solving and production model. Problems are broadcast to an unknown group of solvers in the form of an open call for solutions. These best solutions are then owned by the entity the trust management organization, which is crowd sourcer. By listening to the crowd, the trust management organization can gain first-hand insight on customer desires. The community may feel a brand-building kinship with the crowd sourcing organization, which is result of an earned sense of ownership through contribution and collaboration.

While the crowd sourcing technique is described above in connection with trust management, the technique also may be used within an organization to ask customers how they could make our legal terms and conditions really easy to understand. Customers will send in inputs on language, they will then vote and we will pick the winners. A further use of crowd sourcing for the organization would be to allow customers to engage in product design, either by commenting on a framework or by initiating an idea.

While particular embodiments of the invention have been illustrated and described in detail herein, it should be understood that various changes and modifications might be made to the invention without departing from the scope and intent of the invention.

From the foregoing it will be seen that this invention is one well adapted to attain all the ends and objects set forth above, together with other advantages, which are obvious and inherent to the system and method. It will be understood that certain features and sub-combinations are of utility and may be employed without reference to other features and sub-combinations.

1. A trust management computing system comprising a memory, the memory comprising programmed instructions stored thereon and one or more processors configured to be capable of executing the stored programmed instructions to:
receive a plurality of nominations from one or more social networking users via a social networking system, wherein the plurality of nominations comprises a plurality of participating causes nominated to receive trust funds;
verify when one or more of the nominated participating causes comply with one or more pre-established criteria;
determine one or more categories associated with the one or more of the nominated participating causes based on organizational goals of the one or more of the plurality of nominated participating causes, when the verification indicates that the one or more of the nominated participating causes comply with one or more pre-established criteria;
divide the one or more of the plurality of nominated participating causes based on the determined one or more categories associated with the one or more of the plurality of nominated participating causes;
publish the one or more of the nominated participating causes compliant with the one or more pre-established criteria over the social networking system and invite one or more social networking users via the social networking system to vote for the one or more of the nominated participating causes compliant with the one or more pre-established criteria for a first round of voting;
receive votes from the one or more social networking users for the first round of voting;
determine whether the one or more social networking users providing the votes have an account with a trust management system comprising one or more computing devices;
determine whether the one or more of the nominated participating causes being voted on in the first round of voting are associated with a trust management organization authenticated by the trust management system;
modify weight of each of the votes of the one or more social networking users based on whether a voting social networking user has the account with the trust management system, such that a vote associated with a voting social networking user having an account with the trust management system is weighed more heavily than a vote associated with a voting social networking user that does not have an account with the trust management system;
set a number of votes available to be casted by the voting social networking user based on whether the voting social networking user has the account with the trust management system or not, such that the voting social networking user having the account with the trust management system is entitled to a larger number of votes than the voting social networking user that does not have the account with the trust management system;
receive matching contribution from a computer of the trust management organization if the voting social network user is a member of the trust management organization or if a participating cause receiving the vote is associated with the trust management organization;
link at least one of the one or more social networking users with one of the nominated participating causes based on the vote from the at least one of the one or more social networking users;
identify within each of the one or more categories one of the one or more of the nominated participating causes based on the weighted votes; and
award the trust funds within each of the one or more categories to the identified one of the one or more of the nominated participating causes.

2. The system of claim 1, further comprising
remove one or more nominations from the plurality of nominations based on the weighted votes received during the first round of voting.

3. The system of claim 1, further comprising
determine whether or not each of the one or more social networking users that voted is a member of the trust management organization.

4. The system of claim 3, further comprising
weigh the vote according to membership status, when the determination indicates that the each of the one or more social networking users that voted is the member of the trust management organization.

5. (canceled)

6. The system of claim 1, further comprising
invite one or more of the social networking users to a second round of voting via the social networking system to another vote on the nominated participating causes identified in the first round of voting;
receive votes for the second round of voting; and
modify weight of each of the votes of the one or more social networking users received during the second round of voting based on whether a voting social networking user has an account with the trust management system.

7. The system of claim 6, further comprising
identify one or more of the nominated participating causes identified in the first round of voting based on the weighted votes from the second round of voting; and
award the trust funds to each of the identified one or more of the nominated participating causes identified in the first round of voting based on the weighted votes from the second round of voting.

8-9. (canceled)

10. The system of claim 1, further comprising
provide, at least one user interface for presenting information to the plurality of participating causes nominated and receiving information from the plurality of participating causes nominated.

11. A trust management method comprising:
receiving, by a computing device, a plurality of nominations from one or more social networking users via a social networking system, wherein the plurality of nominations comprises a plurality of participating causes nominated to receive trust funds;
verifying, by the computing device, when one or more of the plurality of nominated participating causes comply with one or more pre-established criteria;
determining, by the computing device, one or more categories associated with the one or more of the nominated participating causes based on organizational goals of the one or more of the plurality of nominated participating causes, when the verification indicates that the one or more of the nominated participating causes comply with one or more pre-established criteria;
dividing, by the computing device, the one or more of the plurality of nominated participating causes based on the determined one or more categories associated with the one or more of the plurality of nominated participating causes;
publishing, by the computing device, the one or more of the nominated participating causes compliant with the one or more pre-established criteria over the social networking system and
inviting, by the computing device, one or more social networking users via the social networking system users to vote for the one or more of the nominated participating causes compliant with the one or more pre-established criteria in a first round of voting;
receiving, by the computing device, the vote from the one or more social networking users for the first round of voting;
determining, by the computing device, whether the one or more social networking users providing the votes have an account with a trust management system comprising one or more computing devices;
determining, by the computing device, whether the one or more of the nominated participating causes being voted on in the first round of voting are associated with a trust management organization authenticated by the trust management system;
modifying, by the computing device, weight of each of the votes of the one or more social networking users based on whether a voting social networking user has the account with the trust management system, such that a vote associated with a voting social networking user having an account with the trust management system is weighed more heavily than a vote associated with a voting social networking user that does not have an account with the trust management system;
setting, by the computing device, a number of votes available to be casted by the voting social networking user based on whether the voting social networking user has the account with the trust management system or not, such that the voting social networking user having the account with the trust management system is entitled to a larger number of votes than the voting social networking user that does not have the account with the trust management system;
receiving, by the computing device, receive matching contribution from a computer of the trust management organization if the voting social network user is a member of the trust management organization or if a participating cause receiving the vote is associated with the trust management organization;
linking, by the computing device, at least one of the one or more social networking users with one of the nominated participating causes based on the vote from the at least one of the one or more social networking users;
identifying, by the computing device, within each of the one or more categories one of the one or more of the nominated participating causes based on the weighted votes; and
awarding, by the computing device, the trust funds within each of the one or more categories to the identified one of the one more nominated participating causes.

12. The method of claim 11, further comprising
removing, by the computing device, one or more nominations from the plurality of nominations based on the weighted votes received during the first round of voting.

13. The method of claim 11, further comprising
determining, by the computing device, whether or not each of the one or more social networking users that voted is a member of the trust management organization.

14. The method of claim 13, further comprising
weighting, by the computing device, the vote according to membership status, when the determination indicates that the each of the one or more social networking users that voted is the member of the trust management organization.

15. (canceled)

16. The method of claim 11, further comprising
inviting, by the computing device, one or more of the social networking users to a second round of voting via the social networking system to another vote on the nominated participating causes identified in the first round of voting;
receiving, by the computing device, the vote for the second round of voting; and
modifying, by the computing device, weight of each of the votes of the one or more social networking users received during the second round of voting based on whether a voting social networking user has the account with the trust management system.

17. The method of claim 16, further comprising
identifying, by the computing device, one or more of the nominated participating causes identified in the first round of voting based on the weighted votes from the second round of voting; and
awarding, by the computing device, the trust funds to each of the identified one or more of the nominated participating causes identified in the first round of voting based on the weighted votes from the second round of voting.

18-19. (canceled)

20. The method of claim 11, further comprising
providing, by the computing device, at least one user interface for presenting information to the plurality of participating causes nominated and receiving information from the plurality of participating causes nominated.

21. A non-transitory machine readable medium having stored thereon instructions for performing a method comprising executable code that, when executed by at least one machine, causes the machine to:
receive a plurality of nominations from one or more social networking users via a social networking system, wherein the plurality of nominations comprises a plurality of participating causes nominated to receive trust funds;
verify when one or more of the plurality of nominated participating causes comply with one or more pre-established criteria;
determine one or more categories associated with the one or more of the nominated participating causes that are compliant with the one or more pre-established criteria based on organizational goals of the one or more of the plurality of nominated participating causes, when the verification indicates that the one or more of the nominated participating causes comply with one or more pre-established criteria;
divide the one or more of the nominated participating causes based on the determined one or more categories associated with the one or more of the plurality of nominated participating causes;
publish the one or more of the nominated participating causes compliant with the one or more pre-established criteria over the social networking system and inviting one or more social networking users via the social networking system to vote for the one or more of the nominated participating causes compliant with the one or more pre-established criteria for a first round of voting;
receive the vote from the one or more social networking users for the first round of voting;
determine whether the one or more social networking users providing the votes have an account with a trust management system comprising one or more computing devices;
determine whether the one or more of the nominated participating causes being voted on in the first round of voting are associated with a trust management organization authenticated by the trust management system;
modify weight of each of the votes of the one or more social networking users based on whether a voting social networking user has the account with the trust management system, wherein a vote associated with a voting social networking user having an account with the trust management system is weighed more heavily than a vote associated with a voting social networking user that does not have an account with the trust management system;
set a number of votes available to be casted by the voting social networking user based on whether the voting social networking user has the account with the trust management system or not, such that the voting social networking user having the account with the trust management system is entitled to a larger number of votes than the voting social networking user that does not have the account with the trust management system;
receive matching contribution from a computer of the trust management organization if the voting social network user is a member of the trust management organization or if a participating cause receiving the vote is associated with the trust management organization;
link at least one of the one or more social networking users with one of the nominated participating causes based on the vote from the at least one of the one or more social networking users;
identify one of the one or more of the nominated participating causes based on the weighted votes; and
award the trust funds within each of the one or more categories to the identified one of the one nominated participating causes.
